(19) United States
(12) Patent Application Publication
(10) Pub. No.: US 2026/0204265 A1
(43) Pub. Date: Jul. 16, 2026

(54) AUDIO DEVICE WITH SPEAKER IDENTIFICATION USING SPEAKER FINGERPRINTS

(71) Applicant: BOSE CORPORATION, Framingham, MA (US)

(72) Inventors: Chuan-Che HUANG, Natick, MA (US); Somasundaram MEIYAPPAN, Chennai (IN); Xiao QUAN, Fairview, NJ (US)

(21) Appl. No.: 19/170,032

(22) Filed: Apr. 3, 2025

(30) Foreign Application Priority Data
Jan. 16, 2025 (IN) 202541003587

(51) Int. Cl. G10L 17/06; G10L 17/02; G10L 17/22

(52) U.S. Cl. CPC G10L 17/06; G10L 17/02; G10L 17/22

(57) ABSTRACT

Techniques, including audio devices and systems implementing the techniques, for performing speaker identification using speaker fingerprints. Such an audio device may be a wearable audio device and include an internal sensor and one or more processors coupled to the internal sensor. The one or more processors may be configured, individually or collectively, to: (i) receive, using the internal sensor, a first input audio signal from a speaker, and (ii) perform, when a plurality of conditions are met, a comparison of one or more audio fingerprints associated with a user of the wearable audio device and the first input audio signal to determine whether the speaker is the user. The plurality of conditions may include the speaker wearing the wearable audio device and the first input audio signal including speech from the speaker.

### CROSS-REFERENCE TO RELATED APPLICATION

This application claims the benefit of and priority to Indian Provisional Application No. 202541003587, filed Jan. 16, 2025, which is incorporated by reference herein in its entirety.

### FIELD

Aspects of the disclosure generally relate to wearable devices, and, more particularly, to techniques to enable an audio device to perform speaker identification using speaker fingerprints.

### BACKGROUND

There is a significant and growing demand for technology that simplifies people's daily lives. Many people are becoming increasingly reliant on devices to manage daily tasks. Audio devices, such as speakers and wearable devices, may provide users with access to a variety of functions to simplify daily, in addition to allowing users to consume entertainment (e.g., movies, television shows, sport events, games, music, podcasts, or other similar entertainment). For example, audio devices may facilitate communication with users of other devices, control smart devices, manage calendar information, document information, access personal information, and/or perform other functions. Often times, users may control these audio device functions using voice commands. Accordingly, methods for audio device control, as well as apparatuses and systems configured to implement these methods, are desired.

### SUMMARY

All examples and features mentioned below can be combined in any technically possible way.

Aspects of the present disclosure provide a wearable audio device. The wearable audio device generally includes an internal sensor and one or more processors coupled to the internal sensor. The one or more processors are generally configured, individually or collectively, to: (i) receive, using the internal sensor, a first input audio signal from a speaker, and (ii) perform, when a plurality of conditions are met, a comparison of one or more audio fingerprints associated with a user of the wearable audio device and the first input audio signal to determine whether the speaker is the user, where the plurality of conditions include the speaker wearing the wearable audio device and the first input audio signal including speech from the speaker.

In aspects, the one or more processors are configured, individually or collectively, to perform the comparison without any wakeup words or phrases configured to initialize the performing of the comparison being included in the first input audio signal.

In aspects, the plurality of conditions further include a preliminary determination that the speaker is the user.

In aspects, the comparison is a text-independent comparison, and where the one or more processors are configured, individually or collectively, to perform the text-independent comparison of the one or more audio fingerprints associated with the user of the wearable audio device and the first input audio signal by comparing the one or more audio fingerprints and any words or phrases included in the speech to determine whether the speaker is the user.

In aspects, the plurality of conditions further include that the speech includes a request from the speaker.

In aspects, the request involves information personal to the user.

In aspects, the one or more processors are configured, individually or collectively, to perform the comparison of the one or more audio fingerprints associated with the user of the wearable audio device and the first input audio signal using a trained machine-learning model.

In aspects, the one or more processors are further configured, individually or collectively, to: receive, using the internal sensor, a second input audio signal from the user, and generate, using a trained machine-learning model, the one or more audio fingerprints based on the second input audio signal.

In aspects, the one or more processors are configured, individually or collectively, to generate the one or more audio fingerprints based on the second input audio signal after a determination that the second input audio signal is from the user.

In aspects, the one or more processors are further configured, individually or collectively, to unlock one or more user functions of the wearable audio device when the speaker is the user.

In aspects, the one or more processors are further configured, individually or collectively, to refrain from unlocking one or more user functions of the wearable audio device when the speaker is not the user.

In aspects, the internal sensor includes a bone conduction sensor.

In aspects, the bone conduction sensor includes one of: an internal microphone disposed inside an ear canal of the user, a microphone facing the ear canal, a voice band accelerometer disposed outside the ear canal, an inertial measurement unit (IMU), or a feedback microphone.

Aspects of the present disclosure are directed to a method. The method generally includes receiving, using an internal sensor of a wearable audio device, a first input audio signal from a speaker, and performing, when a plurality of conditions are met, a comparison of one or more audio fingerprints associated with a user of the wearable audio device and the first input audio signal to determine whether the speaker is the user, where the plurality of conditions include the speaker wearing the wearable audio device and the first input audio signal including speech from the speaker.

In aspects, the plurality of conditions further include a preliminary determination that the speaker is the user.

In aspects, the comparison is a text-independent comparison, and where performing the text-independent comparison of the one or more audio fingerprints associated with the user of the wearable audio device and the first input audio signal includes comparing the one or more audio fingerprints and any words or phrases included in the speech to determine whether the speaker is the user.

In aspects, the plurality of conditions further include that the speech includes a request from the speaker, and where the request involves information personal to the user.

Aspects of the present disclosure provide a non-transitory computer-readable medium including computer-executable instructions that, when executed by one or more processors of a wearable audio device, cause the wearable audio device to perform a method. The method generally includes: receiving, using an internal sensor included in the wearable audio device, a first input audio signal from a speaker, and performing, when a plurality of conditions are met, a comparison of one or more audio fingerprints associated with a user of the wearable audio device and the first input audio signal to determine whether the speaker is the user, where the plurality of conditions include the speaker wearing the wearable audio device and the first input audio signal including speech from the speaker.

In aspects, the plurality of conditions further include a preliminary determination that the speaker is the user.

In aspects, the comparison is a text-independent comparison, and where performing the text-independent comparison of the one or more audio fingerprints associated with the user of the wearable audio device and the first input audio signal include comparing the one or more audio fingerprints and any words or phrases included in the speech to determine whether the speaker is the user.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates an exemplary wireless audio device, in which aspects of the present disclosure may be implemented.

FIG. 3 illustrates example operations for speaker identification using speaker fingerprints performed by a device, according to certain aspects of the present disclosure.

FIG. 4 is a block diagram of an example process flow for speaker identification during the operations of FIG. 3 for speaker identification using speaker fingerprints, according to certain aspects of the present disclosure.

Like numerals indicate like elements.

### DETAILED DESCRIPTION

Certain aspects of the present disclosure provide techniques, including audio devices and systems implementing the techniques, for performing speaker identification using speaker fingerprints. Such techniques may involve receiving (e.g., capturing), using an internal sensor, an input audio signal from a speaker (e.g., a person speaking), and performing, when one or more conditions are met, speaker identification to determine whether the speaker is the user of the audio device (e.g., a user among one or more enrolled or credentialed users of the audio device). The speaker identification may include a comparison of one or more (previously generated) audio fingerprints associated with the user of an audio device and the received input audio signal to determine whether the speaker (from which the input audio signal originates) is the user. In certain aspects, the one or more conditions may include (or in other words, the speaker identification comparison may be performed when) the speaker is wearing (e.g., has donned) the audio device (or at least part of the audio device), and/or only when the speaker is actually speaking (e.g., talking). In some cases, the comparison may be performed without any wakeup words or phrases that initialize (e.g., trigger) the performing of the comparison being included in the received input audio signal. In this manner, the speaker identification may be performed automatically without any specific voice command from the speaker. In certain aspects, the plurality of conditions may include a preliminary determination that the speaker is the user. In some cases, the audio device may have multiple distinct users, and one or more audio fingerprints may be generated for each of the multiple users of an audio device, and the audio device may compare the one or more audio fingerprints associated with each user and the received input audio signal to determine which (if any) user the speaker is.

As described above, there is a significant and growing demand for technology that simplifies people's daily lives, and many people are becoming increasingly reliant on devices to manage daily tasks. Audio devices, such as speakers and wearable devices, may provide users with access to a variety of functions to make daily life easier, in addition to allowing users to consume entertainment (e.g., movies, television shows, sport events, games, music, podcasts, or other similar entertainment). For example, audio devices may facilitate communication (e.g., via voice calls, video calls, electronic messages, and the like) with other people (or other devices of the other people), control smart devices, manage user calendar information (e.g., including booking appointments, vacations, transportation, and the like), document information (e.g., shopping lists, to-do lists, and the like), access personal information (e.g., financial, health, or other private information), make online purchase or payments, and/or perform other functions. Often times, these audio devices may include a voice assistant that operates with a large language model (LLM), and users may control these audio devices (and the voice assistants) using voice commands. However, as users increasingly utilize and rely upon voice commands and voice assistants, especially as voice assistants and LLMs become more and more capable, it becomes all the more important to ensure that someone interacting with the audio devices (voice the assistants) using voice commands is properly identified (or authenticated) as the user (or owner) of the audio device. By properly identifying someone attempting to use an audio device as the user of the audio device, access to any of the user's personal information via the audio device (and the voice assistant) may be controlled.

In some cases, user authentication on an audio device may be provided by identifying the speaker issuing voice commands to the audio device. For example, an audio device may receive (e.g., capture) an input audio signal from the user of a device using an outside sensor (e.g., a microphone located outside of the device, such as a microphone outside the ear canal of the audio device) and generate one or more audio fingerprints associated with the speaker using, for example, a trained machine-learning model (e.g., a neural network). Then, whenever speaker identification is warranted, the audio device may provide an input audio signal speech from the speaker through a speaker identification model (which includes the one or more audio fingerprints) to identify whether the speaker is the user of the audio device. However, someone may try to circumvent such a user authentication to access the user's personal information via the audio device. For example, someone may provide previously recorded (e.g., captured) speech from the user of the audio device to attempt to mimic the one or more audio fingerprints and try to mislead the audio device into thinking that the user of the audio device is present and speaking. In some cases, the previously recorded speech from the user of the audio device may have been obtained, for example, using a recording device in the vicinity of the user.

The present disclosure may enable an audio device to generate one or more audio fingerprints associated with a user of an audio device using an input audio signal from an internal sensor (e.g., a bone conduction sensor and/or transducer, such as an internal microphone inside an ear canal of a user of the device, an internal microphone facing the ear canal on an around ear device, a voice band accelerometer outside the ear canal, a feedback microphone, an inside the earphone microphone, a vibration sensor (accelerometer or otherwise)), as opposed to an input audio signal from an outside sensor. The input audio signal received using the outside sensor appear is distinct from the input audio signal received using the internal sensor. For example, the input audio signal received using the outside sensor appear may include more audio interference compared to the input audio signal received using the internal sensor. Accordingly, audio fingerprints generated using the audio signal received at the outside sensor are different than audio fingerprints generated using the audio signal received at the internal sensor. As a result, someone trying to use previously recorded (e.g., captured) speech from the user of the audio device received using typical outside sensors may have a much more challenging time replicating the audio fingerprints (which are generated using the input audio signal received using the internal sensor) and misleading the audio device into thinking that the user of the audio device is present and speaking.

### An Example System

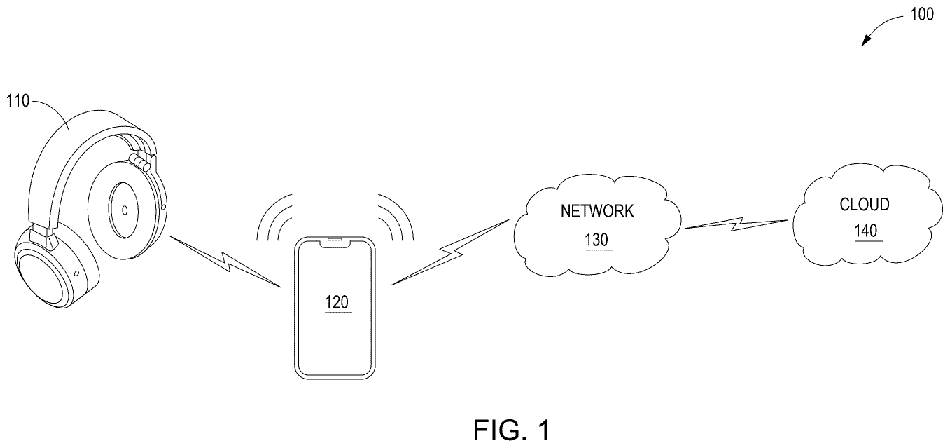

FIG. 1 illustrates an example system 100, in which aspects of the present disclosure may be implemented. As shown, system 100 includes one or more sound processing and playback devices 110 (e.g., a wireless audio device, such as a wearable device as shown in FIG. 1) communicatively coupled with a source device 120 (e.g., a computing device or user device, such as a smartphone, tablet, computer, television, and the like). Throughout the present disclosure, the sound processing and playback device 110 may be referred to simply as the wearable device 110. The wearable device 110 may be configured to be worn by a user and may be a headset that includes two or more speakers and two or more sensors, as illustrated in FIG. 1. The source device 120 is illustrated as a smartphone or a tablet computer wirelessly paired with the wearable device 110. At a high level, the wearable device 110 may play audio content transmitted from the source device 120. The user may use the graphical user interface (GUI) on the source device 120 to select the audio content and/or adjust settings of the wearable device 110. The wearable device 110 provides soundproofing, active noise cancellation, and/or other audio enhancement features to play the audio content transmitted from the source device 120.

In certain aspects, the wearable device 110 includes voice activity detection (VAD) circuitry capable of detecting the presence of speech signals (e.g., human speech signals) in a sound signal received by sensors (not illustrated) of the wearable device 110. For instance, the sensors of the wearable device 110 may be implemented as microphones and may receive ambient and external sounds in the vicinity of the wearable device 110, including speech uttered by the user. The sound signal received by the sensors may have the speech signal mixed in with other sounds in the vicinity of the wearable device 110. Using the VAD, the wearable device 110 may detect and extract the speech signal from the received sound signal. In certain aspects, the VAD circuitry may be used to detect and extract speech uttered by the user in order to facilitate a voice call, voice chat between the user and another person, or voice commands for a virtual personal assistant (VPA), such as a cloud based VPA. In some cases, detections or triggers can include self-VAD (only starting up when the user is speaking, regardless of whether others in the area are speaking), active transport (sounds captured from transportation systems), head gestures, buttons, computing device based triggers (e.g., pause/un-pause from the phone), changes with input audio level, and/or audible changes in environment, among others. The voice activity detection circuitry may run or assist running the phase reconstruction disclosed herein.

In certain aspects, the wearable device 110 includes speaker identification circuitry capable of detecting an identity of a speaker to which a detected speech signal relates to. For example, the speaker identification circuitry may analyze one or more characteristics of a speech signal detected by the VAD circuitry and determine that the user of the wearable device 110 is the speaker (e.g., the originator of the speech signal). In certain aspects, the speaker identification circuitry may use any of the existing speaker recognition methods and related systems to perform the speaker recognition.

The wearable device 110 further includes hardware and circuitry including processor(s)/processing system and memory configured to implement one or more sound management capabilities or other capabilities including, but not limited to, noise canceling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the wearable device 110 by using active noise cancelling (also known as active noise reduction). The sound masking circuitry is configured to reduce distractions by playing masking sounds via the speakers of the wearable device 110. The movement detecting circuitry is configured to use devices/sensors such as an accelerometer, gyroscope, magnetometer, and the like to detect whether the user wearing the wearable device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In certain aspects, the wearable device 110 is wirelessly connected to the source device 120 using one or more wireless communication methods including, but not limited to, Bluetooth, Wi-Fi, Bluetooth Low Energy (BLE), other radio frequency (RF) based techniques, and the like. In certain aspects, the wearable device 110 includes a transceiver that transmits and receives data via one or more antennae in order to exchange audio data and other information with the source device 120.

In certain aspects, the wearable device 110 includes communication circuitry capable of transmitting and receiving audio data and other information from the source device 120. The wearable device 110 also includes an incoming audio buffer, such as a render buffer, that buffers at least a portion of an incoming audio signal (e.g., audio packets) in order to allow time for retransmissions of any missed or dropped data packets from the source device 120. For example, when the wearable device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the wearable device 110. This is done to ensure that even if there are RF collisions that cause audio packets to be lost during transmission, there is time for the lost audio packets to be retransmitted by the source device 120 before the lost audio packets have been rendered by the wearable device 110 for output by one or more acoustic transducers of the wearable device 110.

The wearable device 110 is illustrated as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, hearing aids, or eyeglasses. In certain aspects, the wearable device 110 may be implemented as a banded headset with two cups each configured to deliver audio output.

In certain aspects, the wearable device 110 is connected to the source device 120 using a wired connection, with or without a corresponding wireless connection. The source device 120 may be a smartphone, a tablet computer, a laptop computer, a digital camera, or other computing device that connects with the wearable device 110. As shown, the source device 120 can be connected to a network 130 (e.g., the Internet) and may access one or more services over the network. As shown, these services can include one or more cloud 140 services.

In certain aspects, the source device 120 can access a cloud server in the cloud 140 over the network 130 using a mobile web browser or a local software application or “app” executed on the source device 120. In certain aspects, the software application or “app” is a local application that is installed and runs locally on the source device 120. In certain aspects, a cloud server accessible on the cloud 140 includes one or more cloud applications that are run on the cloud server. The cloud application may be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the wearable device 110 in accordance with aspects of the present disclosure. In certain aspects, examples of the local software application and the cloud application include a gaming application, an audio AR or VR application, and/or a gaming application with audio AR or VR capabilities. The source device 120 may receive signals (e.g., data and controls) from the wearable device 110 and send signals to the wearable device 110.

### An Example Wearable Device

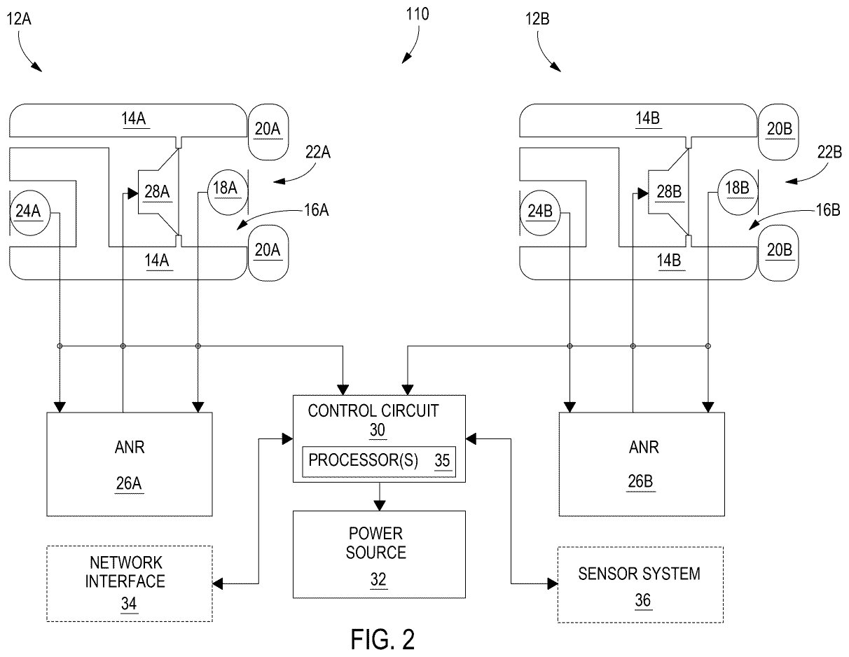

FIG. 2 illustrates an exemplary wearable device 110 and some of its components, in which aspects of the present disclosure may be implemented. Other components may be inherent in the wearable device 110 and not shown in FIG. 2. As shown, the wearable device 110 includes two earpieces 12A and 12B, each configured to direct sound towards an ear of the user. Reference numbers appended with an “A” or a “B” indicate a correspondence of the identified feature with a particular one of the earpieces 12 (e.g., a left earpiece 12A and a right earpiece 12B). Each earpiece 12 includes a casing 14 that defines a cavity 16. In some examples, one or more internal sensors 18 (e.g., inner microphone(s)) may be disposed within cavity 16. In implementations where the wearable device 110 is ear-mountable, an ear coupling 20 (e.g., an ear tip or ear cushion) may be attached to the casing 14 and surround an opening to the cavity 16. A passage 22 is formed through the ear coupling 20 and communicates with the opening to the cavity 16. In some examples, one or more outer sensors 24 are disposed on the casing in a manner that permits acoustic coupling to the environment external to the casing. The inner sensor(s) 18 and the outer sensor(s) 24 may each be implemented and/or referred to as a microphone, an accelerometer, and/or an inertial measurement unit (IMU).

In implementations that include active noise reduction (ANR) (which may include active noise cancellation (ANC) or controllable noise canceling (CNC)), the inner sensor(s) 18 may be an internal microphone(s) or feedback microphone(s) and the outer sensor(s) 24 may be feedforward microphone(s). In such implementations, each earpiece 12 includes an ANR circuit 26 that is in communication with the inner sensor(s) 18 and the outer sensor(s) 24. The ANR circuit 26 receives an inner signal generated by the inner sensor(s) 18 and an outer signal generated by the outer sensor(s) 24 and performs an ANR process for the corresponding earpiece 12. The process includes providing a signal to an electroacoustic transducer 28 (e.g., speaker) disposed in the cavity 16 to generate an anti-noise acoustic signal that reduces or substantially prevents sound from one or more acoustic noise sources that are external to the earpiece 12 from being heard by the user. In addition to providing an anti-noise acoustic signal, the electroacoustic transducer 28 may utilize its sound-radiating surface for providing an audio output for playback (e.g., for a continuous audio feed).

In certain aspects, the wearable device 110 may also include a control circuit 30. The control circuit 30 is in communication with the inner sensor(s) 18, outer sensor(s) 24, and electroacoustic transducers 28, and receives the inner and/or outer microphone signals. In some cases, the control circuit 30 includes one or more microcontroller(s) or processor(s) 35, including for example, a digital signal processor (DSP) and/or an advanced reduced instruction set computer (RISC) machine (ARM) chip. In some cases, the microcontroller(s)/processor(s) (or simply, processor(s)) 35 may include multiple chipsets for performing distinct functions. For example, the processor(s) 35 may include a DSP chip for performing music and voice related functions, and a co-processor such as an ARM chip (or chipset) for performing sensor related functions.

The control circuit 30 may also include analog to digital converters for converting the inner signals from the two inner sensors 18 and/or the outer signals from the two outer sensors 24 to digital format. In response to the received inner and/or outer microphone signals, the control circuit 30 (including processor(s) 35) may take various actions. For example, audio playback may be initiated, paused, or resumed, a notification to a user (e.g., wearer) may be provided or altered, and a device (e.g., a cellular phone, a handheld device, a wireless device, a laptop computer, a tablet, a smartphone, an Internet of things (IoT) device, a wearable device, an AR device, a VR device, etc.) in communication with the wearable device 110 may be controlled. The wearable device 110 may also include a power source 32. The control circuit 30 and power source 32 may be in one or both of the earpieces 12 or may be in a separate housing in communication with the earpieces 12. The wearable device 110 may also include a network interface 34 to provide communication between the wearable device 110 and one or more audio sources or other personal audio devices (e.g., source device 120 as illustrated in FIG. 1). The network interface 34 may be wired (e.g., Ethernet) or wireless (e.g., employ a wireless communication protocol such as IEEE 802.11, Bluetooth, Bluetooth Low Energy (BLE), or other local area network (LAN) or personal area network (PAN) protocols).

The network interface 34 is shown in phantom, as portions of the network interface 34 may be located remotely from the wearable device 110. The network interface 34 may provide for communication between the wearable device 110, audio sources, and/or other networked (e.g., wireless) speaker packages and/or other audio playback devices via one or more communications protocols. The network interface 34 may provide either or both of a wireless interface and a wired interface. The wireless interface may allow the wearable device 110 to communicate wirelessly with other devices in accordance with any communication protocol noted herein. In some particular cases, a wired interface may be used to provide network interface functions via a wired (e.g., Ethernet) connection.

In certain aspects, the network interface 34 may also include one or more network media processor(s) for supporting, e.g., Apple AirPlay® (a proprietary protocol stack/suite developed by Apple Inc., with headquarters in Cupertino, Calif., that allows wireless streaming of audio, video, and photos, together with related metadata between devices) or other known wireless streaming services (e.g., an Internet music service such as: Pandora®, a radio station provided by Pandora Media, Inc. of Oakland, Calif., USA; Spotify®, provided by Spotify USA, Inc., of New York, N.Y., USA); or vTuner®, provided by vTuner. com of New York, N.Y., USA); and network-attached storage (NAS) devices). For example, when a user connects an AirPlay® enabled device, such as an iPhone or iPad device, to the network, the user may then stream music to the network connected audio playback devices via Apple AirPlay®. Notably, the audio playback device can support audio-streaming via AirPlay® and/or DLNA's UPnP protocols, and all integrated within one device. Other digital audio coming from network packets may come straight from the network media processor(s) through (e.g., through a USB bridge) to the control circuit 30. As noted herein, in some cases, the control circuit 30 may include one or more processor(s) and/or microcontroller(s) (simply, “processor(s)” 35), which can include decoders, digital signal processors (DSPs) hardware/software, ARM processor(s) hardware/software, etc. for playing back (rendering) audio content at electroacoustic transducers 28. In some cases, the network interface 34 may also include Bluetooth circuitry for Bluetooth applications (e.g., for wireless communication with a Bluetooth enabled audio source such as a smartphone or tablet). In operation, streamed data can pass from the network interface 34 to the control circuit 30, including the processor(s) or microcontroller(s) (e.g., processor(s) 35). The control circuit 30 may execute instructions (e.g., for performing, among other things, digital signal processing, decoding, and equalization functions), including instructions stored in a corresponding memory (which may be internal to control circuit 30 or accessible via network interface 34 or other network connection (e.g., cloud-based connection). The control circuit 30 may be implemented as a chipset of chips that include separate and multiple analog and digital processors. The control circuit 30 may provide, for example, for coordination of other components of the wearable device 110, such as control of user interfaces (not shown) and applications run by the wearable device 110.

In addition to a processor(s) and/or microcontroller(s), control circuit 30 may also include one or more digital-to-analog (D/A) converters for converting the digital audio signal to an analog audio signal. This audio hardware may also include one or more amplifiers which provide amplified analog audio signals to the electroacoustic transducer(s) 28, which each include a sound-radiating surface for providing an audio output for playback. In addition, the audio hardware may include circuitry for processing analog input signals to provide digital audio signals for sharing with other devices.

The memory in control circuit 30 may include, for example, flash memory and/or non-volatile random access memory (NVRAM). In some implementations, instructions (e.g., software) are stored in an information carrier. The instructions, when executed by one or more processing devices (e.g., the processor(s) or microcontroller(s) in control circuit 30), perform one or more processes, such as those described elsewhere herein. The instructions can also be stored by one or more storage devices, such as one or more (e.g., non-transitory) computer or machine-readable mediums (for example, the memory, or memory on the processor(s)/microcontroller(s)). As described herein, the control circuit 30 (e.g., memory, or memory on the processor(s)/microcontroller(s)) may include a control system including instructions for controlling directional audio selection functions according to various particular implementations. It is understood that portions of the control circuit 30 (e.g., instructions) could also be stored in a remote location or in a distributed location and could be fetched or otherwise obtained by the control circuit 30 (e.g., via any communications protocol described herein) for execution. The instructions may include instructions for controlling device functions based upon detected don/doff events (i.e., the software modules include logic for processing inputs from a sensor system to manage audio functions), as well as digital signal processing and equalization.

The wearable device 110 may also include a sensor system 36 coupled with control circuit 30 for detecting one or more conditions of the environment proximate the wearable device 110. The sensor system 36 may include inner sensor(s) 18 and/or outer sensors 24, sensors for detecting inertial conditions at the personal audio device, and/or sensors for detecting conditions of the environment proximate the wearable device 110, as described herein. Sensor system 36 may also include one or more proximity sensors, such as a capacitive proximity sensor or an IR sensor, and/or one or more optical sensors.

The sensors may be on-board the wearable device 110 or may be remote or otherwise wirelessly (or hard-wired) connected to the wearable device 110. As described further herein, sensor system 36 may include a plurality of distinct sensor types for detecting proximity information, inertial information, environmental information, or commands at the wearable device 110. In particular implementations, sensor system 36 may enable detection of user movement, including movement of a user's head or other body part(s). Portions of sensor system 36 may incorporate one or more movement sensors, such as accelerometers, gyroscopes and/or magnetometers and/or a single IMU having three-dimensional (3D) accelerometers, gyroscopes and a magnetometer.

In various implementations, the sensor system 36 can be located at the wearable device 110 (e.g., where a proximity sensor is physically housed in the wearable device 110). In some examples, the sensor system 36 is configured to detect a change in the position of the wearable device 110 relative to the user's head (e.g., detect the device operating state). Data indicating the change in the position of the wearable device 110 may be used to trigger a command function, such as activating an operating mode of the wearable device 110, modifying playback of audio at the wearable device 110 (e.g., by modifying the audio, noise cancellation (e.g., ANC), or transparency of the wearable device), or controlling a power function of the wearable device 110.

The sensor system 36 may also include one or more interface(s) for receiving commands at the wearable device 110. For example, sensor system 36 may include an interface permitting a user to initiate functions of the wearable device 110. In a particular example implementation, the sensor system 36 may include, or be coupled with, a capacitive touch interface for receiving tactile commands on the wearable device 110.

In other implementations, as illustrated in the phantom depiction in FIG. 2, one or more portions of the sensor system 36 may be located at another device capable of indicating movement and/or inertial information about the user of the wearable device 110. For example, in some cases, the sensor system 36 may include an IMU physically housed in a hand-held device such as a smart device (e.g., smart phone, tablet, etc.) a pointer, or in another wearable audio device. In particular example implementations, at least one of the sensors in the sensor system 36 may be housed in a wearable audio device distinct from the wearable device 110, such as where wearable device 110 includes headphones and an IMU is located in a pair of glasses, a watch, or other wearable electronic device.

In certain aspects, the control circuit 30 is in communication with the inner sensor(s) 18 and receives the two inner signals. Alternatively, the control circuit 30 may be in communication with the outer sensors 24 and receive the two outer signals. In another alternative, the control circuit 30 may be in communication with both the inner sensor(s) 18 and outer sensors 24 and receives the two inner and two outer signals. It should be noted that in some implementations, there may be multiple inner and/or outer microphones in each earpiece 12. As noted herein, the control circuit 30 may include one or more microcontroller(s) or processor(s) having a DSP and the inner signals from the two inner sensor(s) 18 and/or the outer signals from the two outer sensors 24 are converted to digital format by analog to digital converters. In response to the received inner and/or outer signals, the control circuit 30 may take various actions. For example, the power supplied to the wearable device 110 may be reduced upon a determination that one or both earpieces 12 are off-head. In another example, full power may be returned to the wearable device 110 in response to a determination that at least one earpiece becomes on head. Other aspects of the wearable device 110 may be modified or controlled in response to determining that a change in the operating state of the earpiece 12 has occurred. For example, ANR functionality may be enabled or disabled, audio playback may be initiated, paused or resumed, a notification to a wearer may be altered, and a device (e.g., a cellular phone, a handheld device, a wireless device, a laptop computer, a tablet, a smartphone, an Internet of things (IoT) device, a wearable device, an AR device, a VR device, etc.) in communication with the wearable device 110 may be controlled. As illustrated, the control circuit 30 generates a signal that is used to control a power source 32 for the wearable device 110. The control circuit 30 and power source 32 may be in one or both of the earpieces 12 or may be in a separate housing in communication with the earpieces 12.

### Example Operations for Speaker Identification

Certain aspects of the present disclosure provide techniques, including audio devices and systems implementing the techniques, for performing speaker identification using speaker fingerprints. The speaker fingerprints (also referred to herein as audio fingerprints) described herein may be associated with a user of an audio device and be generated using an input audio signal received (e.g., captured) at an internal sensor. The speaker identification may include a comparison of the audio fingerprints associated with a user of an audio device and a received input audio signal to determine whether a speaker (from which the input audio signal originates) is the user. As a result, the audio device may identify whether the speaker is the user (e.g., a user among one or more enrolled or credentialed users of the audio device) before allowing access to audio device functions that involve personal information or functions that are restricted to the user (or users) of the audio device. In certain aspects, the speaker identification comparison may be performed when (i) the speaker is wearing (e.g., has donned) the audio device, and (ii) when the speaker is actually speaking.

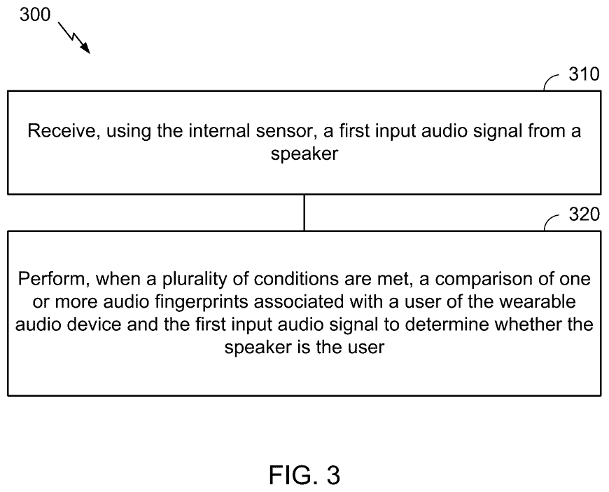

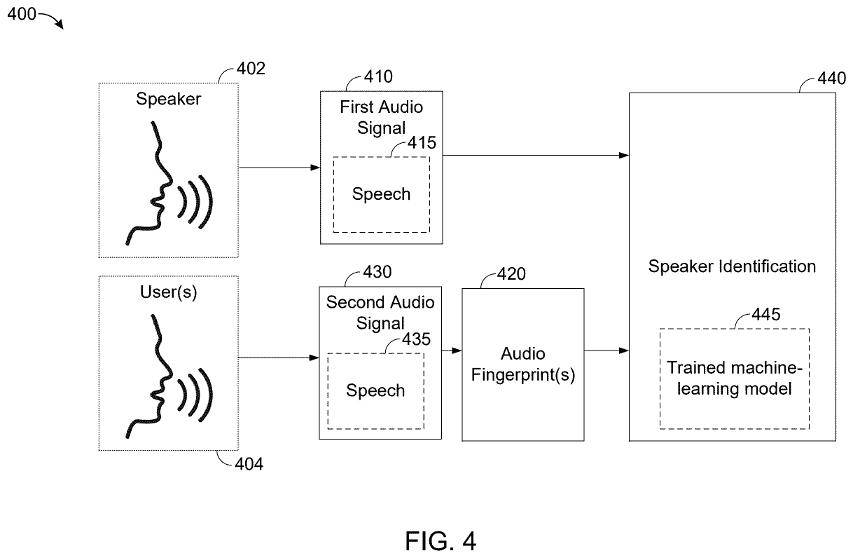

FIG. 3 illustrates example operations 300 for speaker identification using speaker fingerprints performed by a device, according to certain aspects of the present disclosure. FIG. 4 is a block diagram of an example process flow 400 for speaker identification 440 during the operations 300 of FIG. 3 for speaker identification using speaker fingerprints, according to certain aspects of the present disclosure. Therefore, FIGS. 3 and 4 are herein described together for clarity. The operations 300 and the process flow 400 may be performed by an audio device (e.g., the device 110 of FIG. 1 and FIG. 2), or by a control circuit (e.g., control circuit 30) of the device (e.g., using one or more processors, individually or collectively, included in the control circuit 30). The operations 300 and the process flow 400 may be utilized by the device continuously, periodically, or selectively, as will be described herein.

The operations 300 may include, at block 310, receiving, using an internal sensor (e.g., inner sensor(s) 18), a first input audio signal 410 from a speaker 402 (e.g., a person speaking and/or other sound from the speaker 402). The internal sensor may be implemented by, for example, a bone conduction sensor and/or transducer (e.g., an internal microphone inside an ear canal of a user 404 of the device, an internal microphone facing the ear canal on an around ear device, a voice band accelerometer outside the ear canal, a feedback microphone, an inside the earphone microphone, a vibration sensor (accelerometer or otherwise), and the like, which may all be referred to herein simply as internal sensors).

At block 320, the operations 300 may include performing a comparison of one or more audio fingerprints 420 associated with a user 404 of the audio device and the first input audio signal 410 to determine whether the speaker 402 is the user 404 (e.g., a user among one or more enrolled or credentialed users of the audio device). The comparison at block 320 may determine that the speaker 402 is the user 404, or that the speaker 402 is not the user 404. In some cases, the comparison at block 320 may be unable to adequately determine whether the speaker 402 is the user 404. In these cases, the operations 300 may continue to be performed to keep trying to determine whether the speaker 402 is the user 404. For example, the operations 300 may include continuing to receive the first input audio signal 410 from the speaker (e.g., capturing additional speech and/or other sound from the speaker 402), and continuing to perform the comparison at block 320 between the one or more audio fingerprints 420 and the first input audio signal 410 to keep trying to determine whether the speaker 402 is the user 404.

The one or more audio fingerprints 420 at block 320 may be stored on the audio device itself, and/or online in the cloud. In certain aspects, the comparison at block 320 may be performed continuously (e.g., whenever the audio device is powered on). In other aspects, the comparison at block 320 may be performed periodically. For example, the comparison at block 320 may be performed continuously for a period of time (e.g., set by the user 404 or automatically set by the audio device) after the first input audio signal 410 includes speech 415, and then halted for a period of time. In yet other aspects, the comparison at block 320 may be selectively performed when one or more conditions are met. The one or more conditions may include at least one of (i) the speaker 402 wearing (e.g., donning) the audio device (e.g., when the audio device is implemented as a wearable audio device), or (ii) the first input audio signal 410 including speech 415 (e.g., one or more words) from the speaker 402. In this manner, the comparison at block 320 (or all of the operations 300) may be triggered, for example, when the speaker 402 begins to wear the audio device, when the speaker 402 starts to speak, and/or when any of the one or more conditions described herein is met, and the comparison at block 320 may continue to be performed while the speaker 402 is wearing the audio device, when the speaker 402 is still speaking, and/or when any of the one or more conditions described herein is met. In some cases, wearing the audio device may include wearing (or donning) the entirety of the wearable audio device (e.g., wearing both headphones or earbuds), whereas in other cases, wearing the audio device may include wearing (or donning) a portion of the wearable audio device (e.g., wearing one headphone or earbud).

According to certain aspects, the operations 300 may include unlocking one or more user functions of the audio device when the speaker 402 is the user 404 (e.g., when the speaker identification 440 determines that the speaker 402 is the user 404). The operations 300 may include refraining from unlocking the one or more user functions of the audio device when the speaker 402 is not the user 404 (e.g., when the speaker identification 440 determines that the speaker 402 is not the user 404). The one or more user functions may include, for example, communication (e.g., via voice calls, video calls, electronic messages, and the like) with other people (or other devices of the other people), control of one or more smart devices (e.g., smart devices in the home of the user 404 and/or owned by the user 404), management of user calendar information (e.g., including booking appointments and reservations, vacations, transportation, and the like), documenting information (e.g., shopping lists, to-do lists, and the like), access to personal information (e.g., financial (such as banking or investing), health, or other private information), and/or making online purchases or payments. In this manner, audio device functionality that involves user specific information that the user 404 desires to keep private and secured is locked until the audio device identifies the speaker 402 (from which the first input audio signal 410 originates) as the user 404. The user 404 may be able to control and/or adjust (e.g., via a voice assistant of the audio device and/or physical affordance on the audio device) which audio device functions are locked (until the speaker 402 is identified as the user 404) and which audio device functions are unlocked (e.g., accessible to any speaker using the audio device).

In certain aspects, the one or more conditions may include a preliminary determination that the speaker 402 is the user 404. In this manner, the comparison at block 320 may be performed after the audio device has some level of confidence (e.g., a first threshold) that the speaker 402 is the user 404. The operations 300 for speaker identification 440 may, in some cases, provide a greater level of confidence that the speaker 402 is the user 404 (e.g., a second threshold, which may be higher than the first threshold). In some cases, different levels of confidence that the speaker 402 is the user 404 may be used to unlock different audio device functions. In one example, online purchases or payments may be unlocked at the second threshold (e.g., after the operations 300 for speaker identification 440 determine that the speaker 402 is the user 404), whereas management of user calendar information may be unlocked at the first threshold (e.g., after the preliminary determination that the speaker 402 is the user 404).

The preliminary determination may be, for example, a recent (within some period of time, as set by the user 404 or automatically set by the audio device, depending, for example, on the location of the audio device) a previous determination (using the operations 300 or another identification of the speaker 402) that the speaker 402 is the user 404. The preliminary determination may, for example, include outputting (e.g., playing) one or more tones from the audio device (when implemented as a wearable audio device) and analyzing the frequency response associated with the one or more tones to determine (e.g., as a result in differences in ear shapes between people and the like) that the first input audio signal 410 is from the user 404. The preliminary determination may, in some cases, also be an input to the trained machine-learning model 445 that may be used for the speaker identification 440 at block 320 to help improve the accuracy of the trained machine-learning model 445.

In certain aspects, the preliminary determination may be used in conjunction with the audio fingerprints 420 of the operations 300 to determine whether the speaker 402 is the user 404. For example, when the preliminary determination determines that the speaker 402 is the user 404, the operations may use the preliminary determination as a piece of supporting evidence that the speaker 402 is the user 404 during the comparison at block 320.

In certain aspects, the one or more conditions may include that the speech 415 includes a request (e.g., a command) from the speaker 402. In this manner, the comparison at block 320 may be performed when the speaker 402 is attempting to access (e.g., with the request) information in the audio device. The request may involve, for example, information personal to the user 404. In this manner, the comparison at block 320 may be selectively performed when the request involves information personal to the user 404 (which should be secured), and not performed when the request does not involve information personal to the user 404. Information personal to the user 404 may include, as described above, communication (e.g., via voice calls, video calls, electronic messages, and the like) with other people (or other devices of the other people), control of one or more smart devices (e.g., smart devices in the home of the user 404 and/or owned by the user 404), management of user calendar information (e.g., including booking appointments and reservations, vacations, transportation, and the like), documenting information (e.g., shopping lists, to-do lists, and the like), access to personal information (e.g., financial, health, or other private information), and/or making online purchases or payments.

In some cases, the one or more conditions may include that the speech 415 include specific types of requests. For example, the one or more conditions may include that the speech 415 includes a request that involves the information personal to the user 404 described above. In this manner, any audio device functionality (e.g., those functions that are not specific to the user 404 and should be universally available for anyone using the audio device) that is not secured behind the speaker identification 440 may be always available, whereas other audio device functionality (e.g., those functions that are specific to the user 404 and should be available only when the user 404 is using the audio device) may be secured until the speaker 402 is identified as the user 404 at block 320. The division of the audio device functionality that is secured and not secured may be set and/or adjusted by the user (or users) 404 of the audio device). In some cases, the audio device may have multiple users 404, and different audio device functionality may be locked and unlocked for different users.

In certain aspects, the comparison at block 320 may be performed without any wakeup words or phrases configured to initialize (e.g., trigger) the performing of the comparison being included in the first input audio signal 410. That is, the audio device may be capable of performing the comparison at block 320 to determine whether the speaker 402 is the user 404 regardless of whatever words and/or sound are included in the first input audio signal 410. In this manner, the speaker 402 may be able to save time by not having to provide any wakeup words or phrases to begin the operations 300 for speaker identification 440. As described above, the initialization (or trigger) of the comparison at block 320 may instead, in some cases, be when the speaker 402 begins to wear the audio device, when the speaker 402 starts to speak, and/or when any of the one or more conditions described herein is met. In some cases, the operations 300 for speaker identification 440 may be text-independent, such that any words and/or sound from the speaker 402 may be used in the operations 300 for speaker identification 440. In these cases, the comparison at block 320 is a text-independent comparison that may include comparing the one or more audio fingerprints 420 with any words or phrases included in the speech 415 to determine whether the speaker 402 is the user 404.

In certain aspects, the speaker 402 may interact with the audio device (e.g., using a physical affordance and/or a voice command) to initialize the operations 300 for speaker identification 440. In some cases, the comparison at block 320 may be performed as a result of the presence of a wakeup word (or wakeup words) or phrases configured to initialize the performing of the comparison in the first input audio signal 410 (and in the speech 415). For example, the speaker 402 may speak a wakeup word (or wakeup words) or phrases associated with a voice assistant of the audio device to initialize the performing of the comparison at block 320. In this manner, the comparison at block 320 may be a text-dependent comparison that may include comparing the one or more audio fingerprints 420 with the wakeup word (or wakeup words) or phrases included in the speech 415 to determine whether the speaker 402 is the user 404.

In certain aspects, the comparison of the one or more audio fingerprints 420 associated with the user 404 of the audio device and the first input audio signal 410 at block 320 may include using a trained machine-learning model 445. Any of the trained machine-learning models described herein may be implemented by deep learning models. The trained machine-learning models may use various machine learning techniques based on artificial neural networks. For example, any of the trained machine-learning models, when implemented as a deep learning model, may include deep learning architectures, such as deep neural networks, deep belief networks, deep reinforcement learning, recurrent neural networks, convolutional neural networks, transformers, and the like. The trained machine-learning model 445 (and other trained machine-learning models described herein) may continue to learn and attain improved accuracy performing the comparison at block 320 and other functions over time.

According to certain aspects, the operations 300 may include receiving, using the internal sensor, a second input audio signal 430 from the user 404, and generating, using a trained machine-learning model, the one or more audio fingerprints 420 based on the second input audio signal 430. The trained machine-learning model may be the same model as the trained machine-learning model 445, or a separate trained machine-learning model. The second input audio signal 430 may include speech 435, for generating the one or more audio fingerprints 420. In some cases, the one or more audio fingerprints 420 may be continually or periodically generated and/or updated (e.g., using the second input audio signal 430 or other input audio signals originating from the user 404) over time. For example, when the audio device determines that the user 404 is speaking (e.g., without other speakers speaking and/or when limited background noise is present), the one or more audio fingerprints 420 may be updated and/or additional audio fingerprints may be generated using the speech from the user 404 speaking. In this manner, the one or more audio fingerprints 420 may be generated and/or updated to reflect changes in the speech of the user 404 (e.g., due to maturing and/or getting older).

In certain aspects, the one or more audio fingerprints 420 may be generated based on the second input audio signal 430 after a determination by the audio device that the second input audio signal 430 is from the user 404. The determination may be, for example, a recent (within some period of time, as set by the user 404 or automatically set by the audio device) a previous determination (using the operations 300 or another identification of the speaker 402) that the speaker 402 is the user 404. In some cases, the previous determination may include outputting (e.g., playing) one or more tones from the audio device (when implemented as a wearable audio device) and analyzing the frequency response associated with the one or more tones to determine (e.g., as a result in differences in ear shapes between people and the like) that the second input audio signal 430 is from the user 404. The determination may, in some cases, also be an input to the trained machine-learning model 445 that may be used for the speaker identification 440 at block 320 to help improve the accuracy of the trained machine-learning model 445.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A wearable audio device comprising:
an internal sensor;
one or more processors coupled to the internal sensor, the one or more processors being configured, individually or collectively, to:
receive, using the internal sensor, a first input audio signal from a speaker; and
perform, when a plurality of conditions are met, a comparison of one or more audio fingerprints associated with a user of the wearable audio device and the first input audio signal to determine whether the speaker is the user, wherein the plurality of conditions comprise the speaker wearing the wearable audio device and the first input audio signal including speech from the speaker.

2. The wearable audio device of claim 1, wherein the one or more processors are configured, individually or collectively, to perform the comparison without any wakeup words or phrases configured to initialize the performing of the comparison being included in the first input audio signal.

3. The wearable audio device receive of claim 1, wherein the plurality of conditions further comprise a preliminary determination that the speaker is the user.

4. The wearable audio device of claim 1, wherein the comparison is a text-independent comparison, and wherein the one or more processors are configured, individually or collectively, to perform the text-independent comparison of the one or more audio fingerprints associated with the user of the wearable audio device and the first input audio signal by comparing the one or more audio fingerprints and any words or phrases included in the speech to determine whether the speaker is the user.

5. The wearable audio device of claim 1, wherein the plurality of conditions further comprise that the speech includes a request from the speaker.

6. The wearable audio device of claim 5, wherein the request involves information personal to the user.

7. The wearable audio device of claim 1, wherein the one or more processors are configured, individually or collectively, to perform the comparison of the one or more audio fingerprints associated with the user of the wearable audio device and the first input audio signal using a trained machine-learning model.

8. The wearable audio device receive of claim 1, wherein the one or more processors are further configured, individually or collectively, to:
receive, using the internal sensor, a second input audio signal from the user; and
generate, using a trained machine-learning model, the one or more audio fingerprints based on the second input audio signal.

9. The wearable audio device receive of claim 8, wherein the one or more processors are configured, individually or collectively, to generate the one or more audio fingerprints based on the second input audio signal after a determination that the second input audio signal is from the user.

10. The wearable audio device of claim 1, wherein the one or more processors are further configured, individually or collectively, to unlock one or more user functions of the wearable audio device when the speaker is the user.

11. The wearable audio device of claim 1, wherein the one or more processors are further configured, individually or collectively, to refrain from unlocking one or more user functions of the wearable audio device when the speaker is not the user.

12. The wearable audio device of claim 1, wherein the internal sensor comprises a bone conduction sensor.

13. The wearable audio device of claim 12, wherein the bone conduction sensor comprises one of: an internal microphone disposed inside an ear canal of the user, a microphone facing the ear canal, a voice band accelerometer disposed outside the ear canal, an inertial measurement unit (IMU), or a feedback microphone.

14. A method comprising:
receiving, using an internal sensor of a wearable audio device, a first input audio signal from a speaker; and
performing, when a plurality of conditions are met, a comparison of one or more audio fingerprints associated with a user of the wearable audio device and the first input audio signal to determine whether the speaker is the user, wherein the plurality of conditions comprise the speaker wearing the wearable audio device and the first input audio signal including speech from the speaker.

15. The method of claim 14, wherein the plurality of conditions further comprise a preliminary determination that the speaker is the user.

16. The method of claim 14, wherein the comparison is a text-independent comparison, and wherein performing the text-independent comparison of the one or more audio fingerprints associated with the user of the wearable audio device and the first input audio signal comprises comparing the one or more audio fingerprints and any words or phrases included in the speech to determine whether the speaker is the user.

17. The method of claim 14, wherein the plurality of conditions further comprise that the speech includes a request from the speaker, and wherein the request involves information personal to the user.

18. A non-transitory computer-readable medium comprising computer-executable instructions that, when executed by one or more processors of a wearable audio device, cause the wearable audio device to perform a method, the method comprising:
receiving, using an internal sensor included in the wearable audio device, a first input audio signal from a speaker; and
performing, when a plurality of conditions are met, a comparison of one or more audio fingerprints associated with a user of the wearable audio device and the first input audio signal to determine whether the speaker is the user, wherein the plurality of conditions comprise the speaker wearing the wearable audio device and the first input audio signal including speech from the speaker.

19. The non-transitory computer-readable medium of claim 18, wherein the plurality of conditions further comprise a preliminary determination that the speaker is the user.

20. The non-transitory computer-readable medium of claim 18, wherein the comparison is a text-independent comparison, and wherein performing the text-independent comparison of the one or more audio fingerprints associated with the user of the wearable audio device and the first input audio signal comprises comparing the one or more audio fingerprints and any words or phrases included in the speech to determine whether the speaker is the user.
